(19) United States
(12) Patent Application Publication
(10) Pub. No.: US 2016/0036724 A1
(43) Pub. Date: Feb. 4, 2016

(54) Automatic Multi-Application Scanner for Application Migration to Cloud

(71) Applicant: Corent Technology, Inc., Aliso Viejo, CA (US)

(72) Inventors: Shafiullah Syed, Saratoga, CA (US); Balakrishnan Ramalingam, Trichy (IN); Sethuraman Venkataraman, Thiruninravur (IN); Jeya Anantha Prabhu, Chennai (IN)

(21) Appl. No.: 14/815,648

(22) Filed: Jul. 31, 2015

Related U.S. Application Data
(63) Continuation of application No. 14/814,625, filed on Jul. 31, 2015.
(60) Provisional application No. 62/031,462, filed on Jul. 31, 2014.
(60) Provisional application No. 62/031,712, filed on Jul. 31, 2014.

(51) Int. Cl. H04L 12/927; H04L 12/26

(52) U.S. Cl. CPC H04L 47/808; H04L 43/065; H04L 43/50

(57) ABSTRACT

A system for estimating the costs to migrate a non-tenant-aware application to an equivalent tenant-aware application is disclosed. The system scans and identifies local resources used by the non-tenant-aware application and matches the identified local resources with cloud resources capable of sustaining an equivalent tenant-aware application. The system estimates the cost to migrate the non-tenant-aware application based upon the matched resources and exports a summary of the estimated costs.

This application is a continuation of U.S. Pat. No. 14/814625, filed Jul. 31, 2015, which claims the benefit of priority to U.S. Provisional Application No. 62/031712, filed Jul. 31, 2014. This application also claims priority to U.S. Provisional Application No. 62/031462, filed Jul. 31, 2014. All extrinsic materials identified herein are incorporated by reference in their entirety.

### FIELD OF THE INVENTION

The field of the invention is software applications and services.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Computer environments have evolved from localized single user systems, to multi-user systems accessible by geographically distributed users. More recently, as cloud resources have become available, there has been a push to migrate one or more aspects (computer power, memory, storage, etc) of what were previously localized systems into the cloud. This can be done for many reasons, including efficient allocation of resources, cost-effective scalability, improved reliability, improved security, and greater accessibility.

There are numerous issues that arise in executing such migrations, including especially time and cost. For example, many applications are not well suited to a particular cloud environment because (a) cloud environments and their resources are available in a wide variety of configurations and may not pair well with the application's requirements, (b) legacy applications may fail to take advantage of the additional resources offered by a cloud environment and/or (c) applications run inefficiently in a cloud.

U.S. Pat. No. 8,806,015 to Dutta et al. teaches a system that determines workload usage patterns, variability requirements, and reconfiguration requirements of a computerized workload, and place the computerized workload on a selected computer server cluster based on a complimentary usage pattern to the workload resource usage profile. Dutta's system, however, fails to consider the consequences of installing the computerized workload on the selected computer server cluster.

US 2015/0020059 to Davis teaches systems and methods that collects information indicative of migration candidates that correspond to system components and determines migration strategies partially based on that information. Davis, however, still fails to consider the consequences of installing the migration candidates to system components.

US 2014/0282456 to Drost et al. teaches a profiling software that determines efforts associated with migrating the application and uses those estimated efforts to determine which computing environment is most appropriate for the software application. Drost, however, only looks at the costs to deploy the system, but fails to consider ongoing costs while the system is running and in place.

US 2015/0142858 to Bryan et al. performs a pre-migration analysis for a plurality of objects stored in source databases and uses that analysis to generate a plurality of migration scripts to transfer the objects from the databases to target databases. Bryan's pre-migration analysis could identify complex objects that require special handling during the migration and reconfigures those complex objects to reduce the number of instances when the objects are unavailable, optimizing the migration process. Bryan, however, still fails to consider ongoing costs while the system is running and in place.

Thus, there is still a need for systems and methods that efficiently adapt legacy software applications so they may take advantage of the resources and benefits of a cloud environment.

### SUMMARY OF THE INVENTION

The inventive subject matter provides apparatus, systems and methods in which compatibility between any number of software application modules and cloud resources is assessed using a scanning engine, a matching engine, an analysis engine, and a rendering engine.

The scanning engine is preferably configured to identify any number of software application characteristics. The matching engine is preferably configured to perform any number of operations on the identified application characteristics relative to any number of cloud environment characteristics. The analysis engine is preferably configured to generate a summary of the operations of the matching engine. The rendering engine is preferably configured to render a visual representation of the summary to a user.

Of particular interests are systems and methods that compare the application characteristics with the cloud environment characteristics. This comparison can include, for example, the magnitude, requirements, volume, dimensions, specifications, location, compatibility, relationships, dependencies, redundancies, and other comparative aspects. In that manner, the characteristics to be compared can include computational requirements and capacity, computer hours desired and available, data stream throughput desired and available, interface format required and capabilities, services desired and available, support elements desired and available, security protocols desired and available, and other characteristics related to application and resource compatibility comparisons. In a preferred embodiment, the characteristics include network, hardware, and software resources for both applications and cloud resources.

Also contemplated are systems and methods that evaluate the cost associated with the summaries generated by the analysis engine. The summaries can include rankings of the various permutations, recommendations, etc based on the characteristic comparisons generated by the matching engine. In some instances the summaries could provide warning of insufficient information or failure of scanning, matching, analyzing, rendering, or comparing algorithms and/or mechanisms. Additionally, some embodiments contemplate the evaluated cost include required to deploy and operate a particular arrangement of applications on a evaluated cloud arrangements, the initial financial investment to deploy on the cloud, the future costs of maintaining cloud deployment, detrimental impact on business as a result of cloud deployment, and other costs, viewed from both the perspective of a cloud user and a cloud administrator or operator.

Viewed from another perspective, the inventive subject matter provides apparatus, systems and methods that matches local application requirements with cloud resources, transforms any SaaS service deficient application into SaaS capable applications, and non-tenant aware applications into at least appearance of tenant-aware applications, maps the applications efficiently to the cloud resources, and monitors and meters users consumption of cloud resources and SaaS services.

In order to assess the compatibility, benefits, and other software migration factors for migrating one or more locally operated software applications to one or more cloud environments, it is helpful if the modules of each application are mapped onto appropriate cloud environment resources. In order to provide a comprehensive analysis, it can be advantageous to generate as many maps of the application modules as possible, and then apply each module map to the cloud environment resources in as many variations as possible. Once a full list of possible configurations to map the application modules to the cloud environment has been generated, the user can select the most desirable configuration based time, speed, power, cost, or other performance factors.

Once a cloud environment or multiple environments have been selected for a single or multiple local software applications, each software application is preferably transformed to operate in each home cloud environment to facilitate the application (a) running efficiently in the cloud environment, and/or (b) taking advantage of additional resources offered by a cloud environment. Software applications can be individually re-written to resolve those issues, but it is often desirable to provide an automated process for transforming existing software applications (which might be locally based) to operate efficiently in a cloud environment. An automated process for transforming a locally operated software application into a cloud operated software application reduces the delay and cost required to migrate a local application into the cloud.

Once one or more locally operated applications have been migrated into the cloud and configured to operate in the cloud environment, most or even all operations or workloads engaged by the application will likely be performed by the cloud environment resources. In order to efficiently utilize cloud resources, it is helpful to first divide the application's workloads into related groups or partitions, and then assign each partition to a cloud resource. The assignment of partitions to cloud resources can be based on time, speed, power, cost, or other performance factors, that are most desirable for the user.

Once one or more software applications are available for operation in one or more cloud environments, it is desirable to measure and/or meter each user's use of any applications, and each application's use of cloud resources. This metering can be used to charge individual users and/or groups of users for the cost of cloud resources actually consumed by the users rather than based on storage limits, time limits, processor limits, or other forms of block billing. This metering can also be used to charge individual users of the same application separately, based on the user's actual use rather than block billing. This is beneficial because it allows cost sensitive users greater control over the cost of cloud based applications, and allows cloud operators to more efficiently assign and bill for available resources.

In one class of preferred embodiments, a scanner system scans any arrangement of computer servers desirable to a user or operator. This scan helps collect information about the application environment context of the scanned computer servers, as well as the application modules installed on the servers. This can be done for each computer server selected by a user or administrator, until as many or as few of the servers as desired have been analyzed. Once information is collected for some or all desired applications, the modules and corresponding application environment contexts are correlated.

A further subset of embodiments include a matching system used to find and sort matches between modules and computer resources available on a particular cloud or arrangement of clouds. The appeal of migrating an application or group of applications to a particular cloud or arrangement of clouds may be determined using a machine to associate the degree of compatibility between the computer resources of the evaluated cloud environments and the modules of the applications. The result is various configurations of application modules paired with cloud resources with an associated degree of match that helps determine whether the application can be migrated to the evaluated cloud environments. This matching may be applied to one or more cloud environments to compare the migration of an arrangement of applications to one cloud arrangement versus another.

As a further embodiment, a costing system can determine the cost, effort, and time for migrating desired arrangements of applications to particular arrangements of cloud environments. Such costing may be extended to assess the cost of migration to more than one cloud arrangement. Additionally, a comparison may be generated to pick a cloud arrangement with desirable cost tradeoffs from among multiple cloud arrangements.

In interpreting descriptions in this Specification, groupings of alternative elements or embodiments of the inventive subject matter are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a multi-tenant application with its modules mapped to hardware and software resource contexts.

FIG. 2 is a schematic showing how a multi-application scanner can determine if an application can be migrated to a cloud.

FIG. 3 is a schematic showing a scanner operating on multiple applications installed on a group of computer servers.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Computer devices that are

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

It should be noted that any language directed to a computer or a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

Regarding transformation of a non-tenant aware application to an application that operates with multiple tenants, one could modify the application according to teachings of W02008042984 (Hofhansl) and US20100005055 (An), or modify the application environment context according to teachings of U.S. Pat. No. 8,3,26,876 (Venkatraman) or US2010/0005443 (Kwok). Co-owned U.S. Pat. No. 8,326,876 (Venkataraman) also discloses multi-tenant agile database connectors that could be used to transform a locally-based application into a multi-tenant application system.

These and all other publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

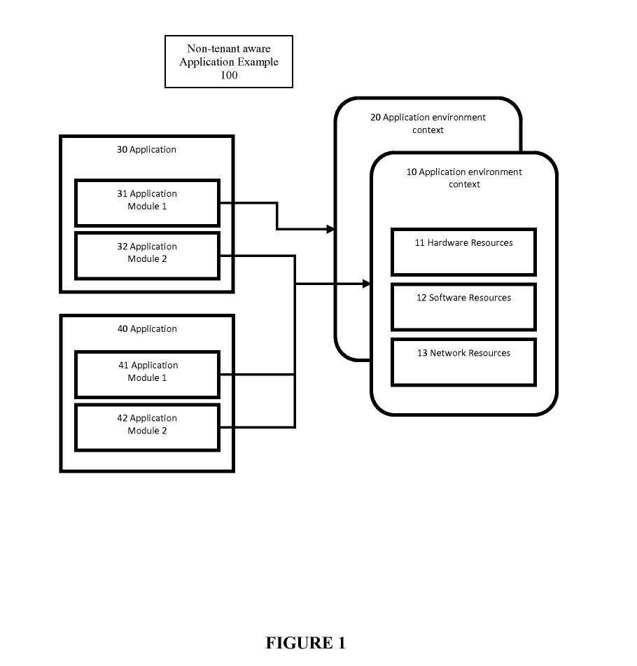

In FIG. 1, application example 100 shows two different non-tenant-aware application environment contexts—application environment context 10 and application environment context 20. Each non-tenant-aware software application 30 and 40 has an application environment context, which is mapped to a computer server configured to instantiate instances of a multi-tenant application. Each application environment context is associated with one set of hardware, software and network resources denoted by 11, 12 and 13, for example a processor/non-transient memory/user interface, a multi-tenant software system, and network connectivity to connect to other computers, respectively. Application environment context 20 similarly has hardware, software, and network resources (not shown). Application 30 comprises a plurality modules, represented euphemistically as module 31 and module 32, and application 40 also comprises a plurality of modules, represented euphemistically as module 41 and module 42. Each module is preferably associated with an application context. For example, application module 31 is associated with application environment context 20, while application modules 32, 41, and 42 are associated with application environment context 10.

By sharing a single application server context with a plurality of applications, resources can be effectively utilized to benefit customers by reducing the number of resources needed to execute multi-tenant applications on shared computers. Here, the hardware, software, and network resources of application environment context 10 are shared with both application 30 and application 40. These environments represent non-tenant-aware application environments that are typically found in the field before being migrated and/or transformed into tenant-aware applications in the cloud.

The system typically analyzes the application environment context of each application and compares them with and/or correlates them with the cloud environment context and/or resources of any arrangement of clouds.

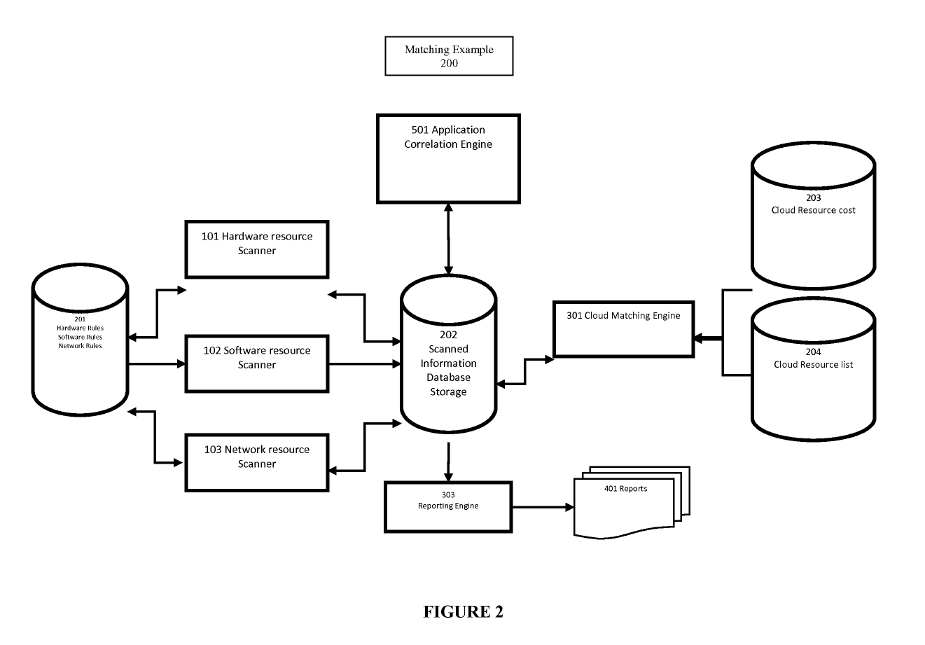

In FIG. 2, a matching example 200 shows three scanners—hardware resource scanner 101, software resource scanner 102, and network resource scanner 103. Database 201 holds scanning rules for each of the scanners, which scans each corresponding resource (e.g. hardware resource scanner 101 analyzes hardware systems, software resource scanner 102 analyzes software systems, and network resource scanner 103 analyzes network systems) as a function of the rules to determine how each type of resources needs to be scanned. For example, an administrator user might use a user interface to configure the hardware resource scanner to determine the memory capacity and the amount of CPU cycles a non-tenant-aware application takes to perform a task on one or more computer systems, or the administrator might wish to know how much traffic is typically sent between a terminal and the non-tenant-aware application, or the non-tenant-aware application and a NAS database, within a certain period of time. The scanned information from the various resources that are scanned are stored in the scanned information database storage 202.

The application correlation engine 501 examines the scanned hardware, software, and network resources and correlates them to the appropriate application, application modules, etc. Essentially, application correlation engine 501 is configured to analyze the scanned data to construct a virtualized representation of how applications, application modules, and application environment contexts are currently mapped, such as the schematic shown in FIG. 1. By constructing such a map, the application correlation engine could list what hardware/software/network resources would be needed to run one specific module of an application, to run all modules of the application, to run modules of several applications, or to run selected modules of several applications. Once a map is constructed and presented to a user interface, an administrator user preferably selects one or more of the modules to be exported to a tenant-aware application, and the system could perform an analysis regarding what cloud resources would be needed in order to export the non-tenant-aware application to a cloud-based tenant-aware application. Once application correlation engine 501 determines how the local resources are mapped to the non-tenant-aware applications, this information is saved in scanned information database storage 202. The compatibility and/or cost of migrating a particular arrangement of applications into a particular arrangement or series of arrangements of cloud environments is preferably determined by the properties of application correlation engine 501.

Cloud matching engine 301 uses the cloud resource list 204 of one or more clouds and cloud resource cost database 203 to pick the best matching instance for any selected application, application module, set of application modules, or application resource context available in the scanned information database 202. The result is stored back into the scanned information database 202. This operation can be performed for multiple clouds, each with its corresponding cost from the cloud resource list. Various algorithms could be used to determine what would be the “best” matching instance for any selected application attribute. For example, a simple algorithm would be to optimize the cloud resources based upon the lowest cost to purchase the cloud resources. Another algorithm would be to optimize the cloud resources based upon the fastest cloud resources available. Another algorithm could anticipate growth on the cloud resources, and could look for cloud resources that are 20% more capable (e.g. 20% more memory, 20% more CPU processing power, and 20% more network bandwidth) than the scanned local resources. Such settings are preferably configured by an admin user.

Cloud matching engine 301 uses the cost information from cloud resource cost database 203 to calculate the cost of each set of constructed cloud instances. As used herein, a “cloud instance” is a set of cloud resources set forth by the cloud matching engine as a potential set of cloud resources that could be used by a tenant-aware application that will be a tenant-aware equivalent to the non-tenant-aware application to be migrated. This can be repeated for each cloud in cloud resource list 204 to determine the cost structure that fits the needs of the customer. The matching information is also preferably stored on scanned information database storage 202.

Reporting engine 303 reads information stored in scanned information database 202 to create one or more reports 401 that are exported to a user interface (not shown). Typically, reporting engine 303 will report the costs of at least one cloud instance that could be used in a non-tenant-aware application migration to a cloud-based tenant-aware application. Preferably, reporting engine 303 will report a plurality of cloud instances and costs for different optimization algorithms, for example one algorithm that minimizes cost and another algorithm that anticipates a 30% growth along selected resources.

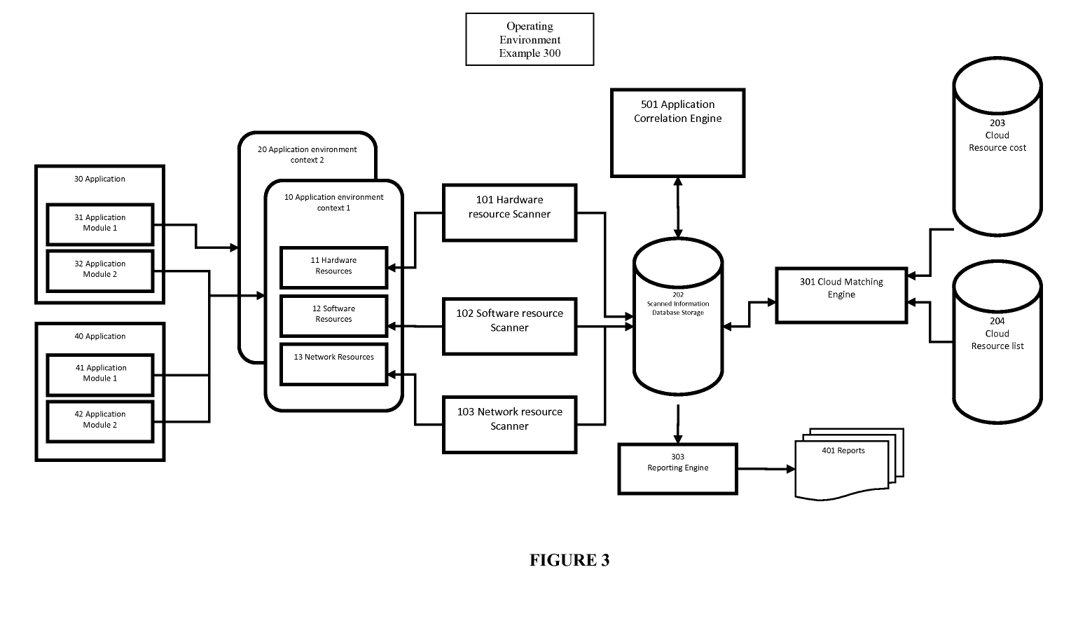

FIG. 3 illustrates an operating environment example 300, specifically configured on one or more computer systems to properly allocate application modules to associated application environment contexts. Here, two multi-tenant applications, application 30 and application 40, each comprise a plurality of modules. Application 30 has modules 31 and 32, while application 40 has modules 41 and 42.

Application module 31 is using hardware, software, and network resources from application environment context 20, while application modules 32, 41, and 42 is using hardware, software, and network resources from application environment context 10.

The each of the scanners are provided a list of computer servers in the multi-tenant system environment. The scanners then scan each of the computer servers in the environment to determine each computer's resources, and determine which application environment contexts exist on the servers, and determine which modules are allocated to each application environment context.

The scanned information is stored into scanned information database storage 202.

The application correlation engine 501 reads all the modules from the scanned information database 202, matches against the dependencies for every application and creates a correlation map for every application.

The cloud matching engine 302, reads the scanned information about the application modules and the application environment context and matches against the cloud resource cost database 203 to find an exact match. If an exact match is not possible, the engine provides the best nearest match to migrate the application. This information is stored back into the scanned information database.

The cloud costing engine 301, reads the information on matched cloud instances, which was previously determined by 302 and computes the cost of the application, once migrated to the cloud.

The cloud costing engine will computer the cost for multiple clouds and determine the cost. The computed cost is stored back in the scanned information database.

The reporting engine 303 creates reports dynamically to suggest the cloud matches for every application and the associated cost and displayed as multiple reports 401.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for evaluating compatibility, comprising:
a scanning engine configured to identify a set of local resources used by a non-tenant-aware application;
a matching engine configured to match the identified set of local resources with a set of cloud resources for an equivalent tenant-aware application;
an analysis engine configured to estimate a cost to migrate the non-tenant-aware application to the equivalent tenant-aware application as a function of the matched set of cloud resources;
a rendering engine that presents a representation of the cost a user interface.

2. The system of claim 1 wherein the local resources is selected from the group consisting of a hardware characteristic, a network characteristic, and a software characteristic.

3. The system of claim 1, wherein the scanning engine is further configured to identify an application environment context comprising hardware resources, software resources, and network resources used by the non-tenant-aware application.

4. The system of claim 3, wherein the scanning engine is further configured to identify a set of application modules of the non-tenant-aware application utilizing the identified application environment context.

5. The system of claim 3, wherein the scanning engine is further configured to save the application environment context into a database storage area for analysis.

6. The system of claim 1, further comprising an application correlation engine configured to correlate the identified application environment context with the non-tenant aware application.

7. The system of claim 6, wherein the application correlation engine is further configured to correlate a set of application modules of the non-tenant-aware application utilizing the identified application environment context with the non-tenant aware application.

8. The system of claim 1, wherein the matching engine is further configured to match the identified set of local resources with a set of cloud resources as a function of optimized cost.

9. The system of claim 1, wherein the matching engine is further configured to match the identified set of local resources with a set of cloud resources as a function of optimized performance.
